(19) United States
(12) Patent Application Publication
(10) Pub. No.: US 2003/0005808 A1
(43) Pub. Date: Jan. 9, 2003

(54) Mercer's sound post, bridge, and tailpiece sound transfer system for the violin family

(76) Inventor: James A. Mercer II, Hampton, VA (US)

Correspondence Address: JAMES A. MERCER II, 12496 WARWICK BLVD., NEWPORT NEWS, VA, 23606, US

(21) Appl. No.: 09/901,537

(22) Filed: Jul. 9, 2001

(51) Int. Cl. G10D 3/04

(52) U.S. Cl. 84/307

(57) ABSTRACT

The present invention transfers sound vibrations to all parts of the violin, or henceforth any member of the violin family, in a more efficient way. As to transmit the sound or vibrations with less loss of these sound vibrations. This system gives members of the violin family a clearer, softer, yet louder more beautiful tone. It consists of three parts: a new and better bridge, a different and better sound post, and a newly designed tailpiece.

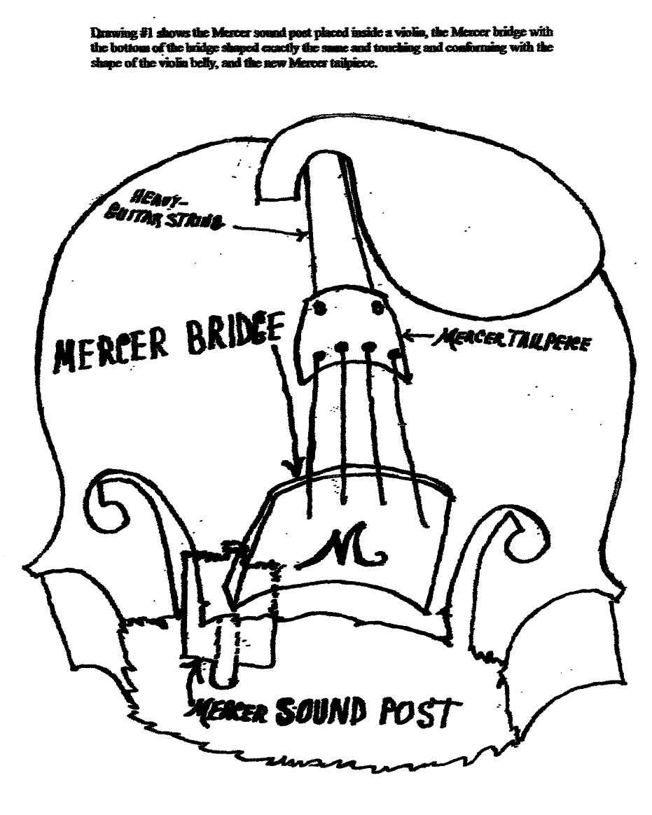

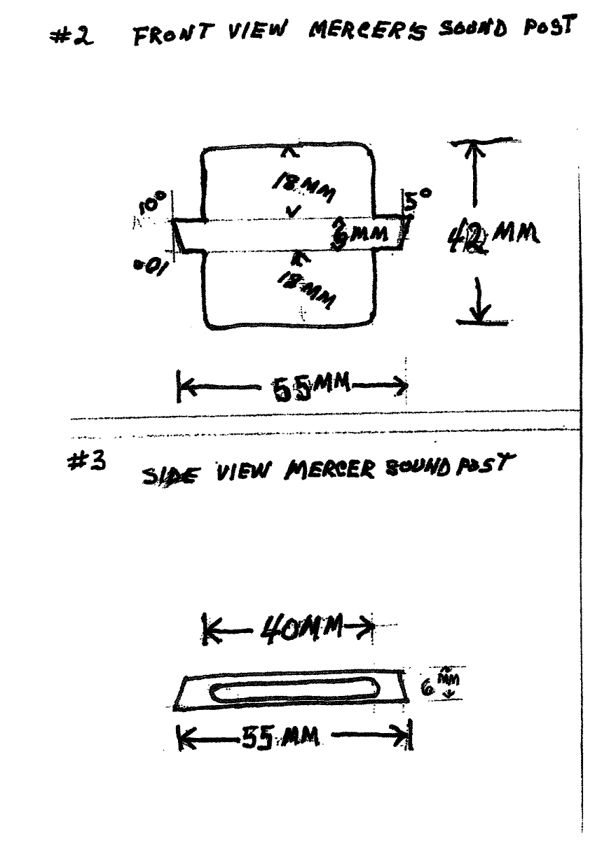

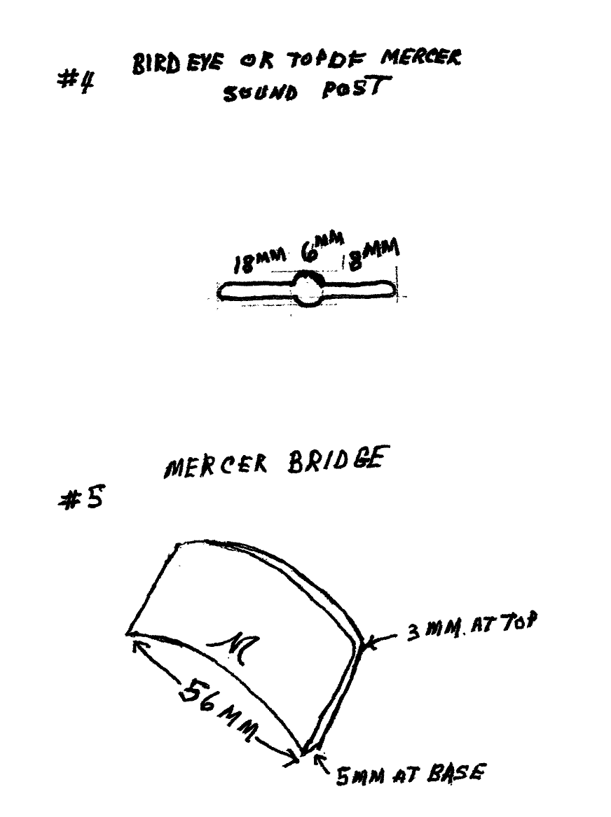

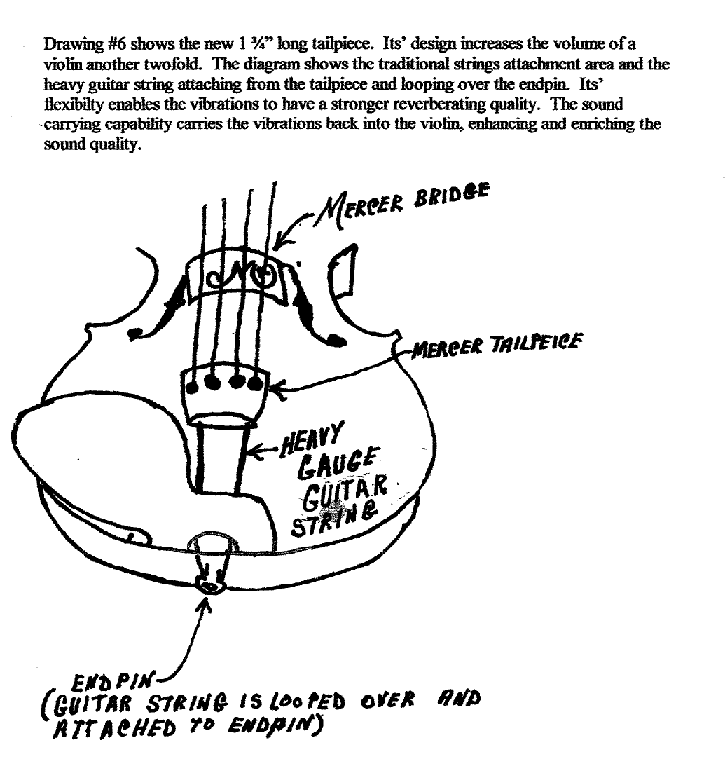

### DESCRIPTION

The invention is to improve the sound of any violin or member of the violin family. The violin musical instrument has a fingerboard. Its' strings are attached to tuning pegs and to a tailpiece passing over a bridge held in place by the pressure of the strings. The bridge transmits the strings' vibrations to the violin belly, or soundboard, which amplifies the sound. Inside the instrument, beneath the treble foot of the bridge and wedged between the violin's belly and back is the sound post, a round stick of spruce that transmits the strings vibrations to the instruments back, contributing to the characteristic violin tone. The belly is supported from beneath by the bass bar, a narrow wood bar running lengthwise and tapering into the belly. It also contributes to the resonance of the instrument. The new Mercer sound post now contributes to the resonance of the instrument. The new Mercer bridge carries the sounds to all parts of the violin.

### SUMMARY OF THE INVENTION

The present invention is improvement in the way sound is transferred to the various parts of the violin (or family of the violin). The invention consists of a bridge, a sound post, and a tailpiece. The bridge is wider and different than a regular bridge in that the entire bottom touches the belly of the violin. It has no fancy carvings or holes to lose any vibration. It could have these things for aesthetic appearance but would distract slightly from the vibration transfer. The sound post has outward wings to pick up a more complete spectrum of sound. The tailpiece allows for a longer string length and is designed to carry vibrations back to the violin.

The object of the invention is to make all members of the violin family sound more beautiful to the human ear.

Another object is to bring an end to the once thought of image that only the wealthy can have a beautiful sounding violin. In other words, this invention will make very high-grade violins more affordable.

### SPECIFICATION

Through the use of three newly designed violin parts a superior sounding violin is produced. There are two very small 1/16″ holes drilled into the Mercer style sound post. A 16″ 22 gauge traditional florist wire is passed through the holes and attached to the sound post. This allows for the attached sound post to be manipulated into place inside the violin. With traditional sound post setting tools the Mercer sound post is pushed and pulled into position so that it is a tight fit. It is recommended to wet the wood on the belly and back where the sound post touches. This causes the wood to swell up slightly and helps seat the sound post into place. It should dry in about 24 hours. Next the wire is removed from the Mercer sound post. This completes the proper installation of the Mercer sound post. The wider Mercer bridge is installed next. As stated it is a wider 56 mm bridge. The bottom surface of the bridge takes on and seats precisely into the shape of the belly of the violin. The entire bottom of the bridge touches the surface of the violin belly. This allows sound vibrations from the strings to be passed through every possible area of the bottom of the bridge (all the way across the bottom of the bridge). by A rather simple procedure fits the Mercer bridge into place. The Mercer bridge is placed into a standard violin tool called a bridge foot fitter (which allows correct fitting of the bottom of the bridge). Next a piece of #220 grit self adhesive sand paper is placed on the belly of the violin in the area of the F holes. The tool, which holds the bridge at a precise angle is slid back and forth (grinding the Mercer bridge to the exact shape of the violin belly). Using the existing bridge as a template, the top shape of the Mercer bridge can be marked for the string grooves, completing this step.

The Mercer tailpiece is much easier to install, as it is an exterior part. It is composed of the traditional standard tailpiece strings attachment area, but that area ends and is only ¼″ to 1%″ long. Attached to the outer two sides or outside perimeter is a heavy gauge guitar string, which is looped over and attached to the traditional violin endpin. Thus carrying the sound vibration back into the violin. The design of this tailpiece also allows the violin strings to span a slightly longer distance. This increased distance adds to the resonance when placed on the violin. This new tailpiece design increases the volume another twofold.

For the purpose of clarifying the nature of the Mercer sound post, bridge, and tailpiece sound transfer system for the violin family. One exemplary embodiment of the invention is illustrated in the description and drawings and is described in detail hereafter. There can be multiple embodiment of the invention, which lay within the scope of the invention.

Drawing #1 shows the Mercer sound post placed inside a violin. The drawing shows the Mercer bridge with the bottom surface of the bridge fitting together with the belly of the violin and duplicating the precise shape of the belly. It also shows the tailpiece drawing.

Drawing #2 shows a front view of the Mercer sound post.

Drawing #3 shows the side view of the Mercer sound post. This shows the wings as thinner wood so they can pick up and transfer sound vibrations better.

Drawing #4 shows a top view of the sound post.

Drawing #5 shows the shape of the Mercer bridge. The bottom shape must fit exactly with the top of the violin belly, so that the bottom of the bridge touches the violin belly all the way across.

Drawing #6 shows the Mercer tailpiece.

These drawings show the three components of the invention. These components can be used independently of each other and obtain good results, but for the best results it is recommended that all components be used.

What I claim as my invention is that the wider Mercer bridge is constructed in such a way as to have more surface area touching the violin belly or top.

1. The mercer bridge causes all members of the violin family to transfer the intended beautiful sound of the stringed instrument to the violin belly in a more efficient manner:
The Mercer bridge causes a more total spectrum of sound vibrations.

2. What I claim as my invention is the Mercer sound post which is constructed in such a way that it not only carries sound to the bottom of the violin, but also picks up sound vibrations as it is doing so.
These additional sound vibrations are also carried to all parts of the violin.
This gives the violin a clearer, louder, and more beautiful tone.
The lack of lost vibrations gives the violin its' intended total spectrum of sound.

3. What I claim as my invention is the Mercer tailpiece, which is constructed in such a way that it carries the vibrations from the strings back into the violin, giving the violin a clearer, louder, and more reverberating sound.
Once again the vibrations are not lost.
The Mercer tailpiece is more flexible.
The newly designed Mercer tailpiece gives all members of the violin family an intensified and enriched resonant quality, and increase the volume another twofold.
